(19) United States
(12) Patent Application Publication
(10) Pub. No.: US 2022/0161302 A1
(43) Pub. Date: May 26, 2022

(54) METHOD FOR TAKING OUT METAL PART FROM ELECTRICAL APPLIANCE

(71) Applicant: ITO Ryoko, Osaka-shi, Osaka (JP)

(72) Inventor: Tomoaki ITO, Osaka (JP)

(21) Appl. No.: 17/433,913

(22) PCT Filed: Jan. 15, 2020
(86) PCT No.: PCT/JP2020/001092

§ 371 Date: Aug. 25, 2021

(30) Foreign Application Priority Data
Feb. 26, 2019 (JP) 2019-032622

(51) Int. Cl. B09B 3/45; B09B 3/32

(52) U.S. Cl. CPC B09B 3/45; B09B 2101/15; B09B 3/32

(57) ABSTRACT

There is provided a method for efficiently taking out a metal part coated with a thermosetting resin from an electrical appliance which is no longer needed. Included are a step in which the electrical appliance is exposed to an atmosphere filled with superheated steam to carbonize the thermosetting resin, a step in which an impact is applied to the thermosetting resin which is made fragile by carbonization to cause destruction and a step in which the metal parts are separated from the destroyed thermosetting resin.

### TECHNICAL FIELD

The present invention relates to a method for taking out a useful metal part from an electrical appliance which is no longer needed and is suitable for a case in particular where the metal part is coated with a thermosetting resin.

### BACKGROUND OF THE INVENTION

Useful metal parts such as copper wires, etc. are used in an electrical appliance such as a motor, a transformer, a capacitor, etc. When an electrical appliance is no longer needed and discarded, metal parts such as copper wires are taken out and recycled. In most cases, these metal parts are partially or entirely coated with a thermosetting resin for protecting the copper wires, etc. Therefore, a saw or a cutting tool is used to cut and remove the thermosetting resin to take out the metal parts.

As a method for processing organic waste such as kitchen waste, food scraps, etc., there is known a method in which superheated steam is brought into contact with organic waste in an oxygen-free state to process the waste by carbonization (for example, Patent Literature 1).

### PRIOR ART LITERATURE

### Patent Literature

Patent Literature 1: International Publication No. 2016/185631

### SUMMARY OF THE INVENTION

### Problems to be Solved by the Invention

A conventional method for taking out a metal part requires cutting of a hard thermosetting resin by using a saw or a cutting tool and, therefore, is extremely low in work efficiency due to the amount of time required for processing a single electrical appliance.

The present invention has been made in view of the above description and an object thereof is to provide a method for efficiently taking out a metal part coated with a thermosetting resin from an electrical appliance which is no longer needed.

### Means for Solving the Problem

In order to solve the above problem, the present invention is constituted as follows. That is, the method for taking out a metal part from an electrical appliance according to the present invention is applicable to a case where the metal part is taken out from an electrical appliance which contains a metal part coated with a thermosetting resin, and the method includes a step in which the electrical appliance is exposed to an atmosphere filled with superheated steam to carbonize the thermosetting resin, a step in which an impact is applied to the thermosetting resin which is made fragile due to carbonization to cause destruction and a step in which the metal part is separated from the destroyed thermosetting resin. A temperature of the superheated steam is, for example, within a range of 200° C. to 600° C.

### Effects of the Invention

In the method for taking out a metal part from an electrical appliance according to the present invention, the electrical appliance is exposed to an atmosphere filled with superheated steam to carbonize a thermosetting resin, and the thermosetting resin is thereby made fragile. Thus, the thermosetting resin is easily destroyed by applying an impact with a hammer, etc. It is, therefore, possible to easily separate the metal part from the thermosetting resin and efficiently take out the metal part.

### BRIEF DESCRIPTION OF DRAWINGS

FIG. 1 is a perspective view which shows one example of an electrical appliance processed by a method for taking out a metal part from an electrical appliance according to the present invention.

FIG. 2 is a view which describes a first step of the method for taking out a metal part from the electrical appliance.

FIG. 3 is a view which describes a second step of the method for taking out a metal part from the electrical appliance.

FIG. 4 is a view which describes a third step of the method for taking out a metal part from the electrical appliance.

### MODE OF CARRYING OUT THE INVENTION

Hereinafter, a description will be given of a preferred embodiment of the present invention with reference to drawings.

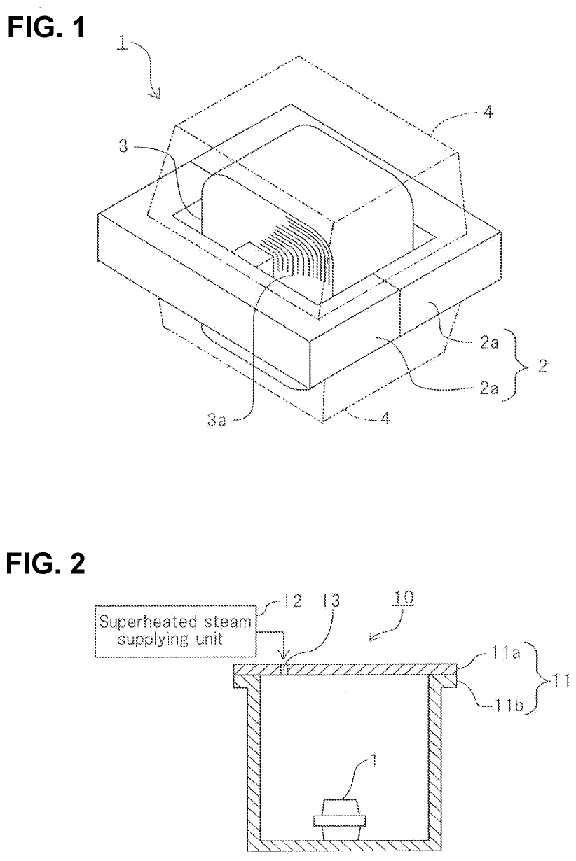

FIG. 1 shows an example of the electrical appliance which is processed by the method for taking out a metal part from an electrical appliance according to the present invention. The electrical appliance 1 is a transformer and has an iron core 2 and a coil 3 which is wound around the iron core 2. In this example, the iron core 2 has a structure in which two E-shaped cores 2a, 2a are combined, but may have another structure. The coil 3 is constituted of an insulation-coated copper wire 3a. In order to insulate and protect the coil 3, an entirety of the coil 3 and a part of the iron core 2 are coated with a thermosetting resin 4 such as a phenol resin, an epoxy resin, an unsaturated polyester resin, etc.

The iron core 2 and the coil 3 of the electrical appliance 1 are useful metal parts which can be recycled. These metal parts are taken out through the following individual steps.

In the first step, the electrical appliance 1 is exposed to an atmosphere filled with superheated steam to carbonize the thermosetting resin 4. As shown in FIG. 2, a carbonization processing apparatus 10 used in this processing is constituted of a carbonization processing furnace 11 into which the electrical appliance 1 is put and a superheated steam supplying unit 12 which supplies superheated steam into the carbonization processing furnace 11. The carbonization processing furnace 11 is constituted of a furnace main body 11a, an upper portion of which is open, and a lid 11b which closes an upper opening of the furnace main body 11a, and the superheated steam supplied from the superheated steam supplying unit 12 is introduced into the furnace through a superheated steam supplying port 13 provided on the lid 11b.

A temperature of the superheated steam inside the carbonization processing furnace 11 is within a range of 200° C. to 600° C. and processing time is about 10 to 120 minutes. The temperature of the superheated steam and the processing time are determined by the type of the thermosetting resin 4, the volume of the thermosetting resin 4, etc. As described so far, the electrical appliance 1 is processed by the superheated steam, by which the thermosetting resin 4 is carbonized and made fragile. According to actual data, in a case of two tons of transformers, effectiveness was found when the processing was conducted at 450° C. for two hours.

It is noted that FIG. 2 is a view for schematically showing a constitution of the carbonization processing apparatus 10, and the carbonization processing apparatus 10 is not limited to this constitution. There can be used, for example, a carbonization processing apparatus described in Patent Literature 1. Further, although only one electrical appliance 1 is processed by the carbonization processing furnace 11 in FIG. 2, the plurality of electrical appliances 1 may be processed at the same time.

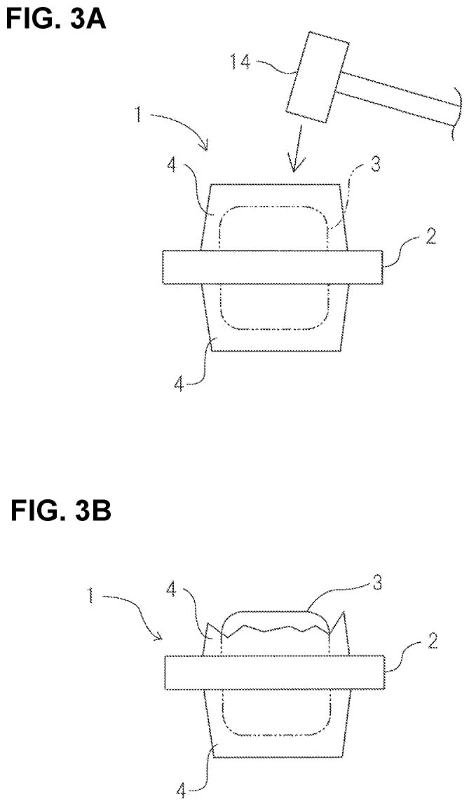

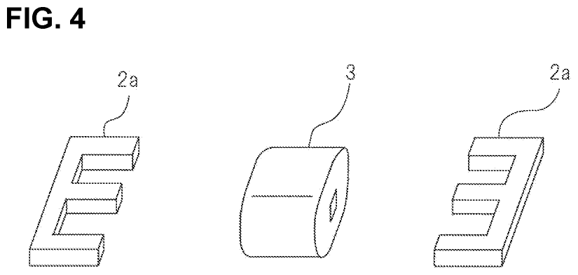

In the second step, an impact is applied to destroy the thermosetting resin 4 which is made fragile by carbonization. For example, as shown in FIG. 3(a), a hammer 14 is used to apply an impact to the thermosetting resin 4, by which the thermosetting resin 4 is easily destroyed as shown in FIG. 3(b). If necessary, the hammer 14 maybe used to apply an impact repeatedly to further destroy the thermosetting resin 4.

In the third step, a metal part is separated from the destroyed thermosetting resin 4. Thereby, the two E-shaped cores 2a, 2a and the coil 3 are obtained as the metal parts.

According to the above-described method, the electrical appliance 1 is exposed to an atmosphere filled with superheated steam to carbonize the thermosetting resin 4, by which the thermosetting resin 4 is made fragile. Thus, a hammer, etc., is used to apply an impact to easily destroy the thermosetting resin 4. It is, therefore, possible to easily separate the iron core 2 and the coil 3 from the thermosetting resin 4 and efficiently take out the iron core 2 and the coil 3.

In the above description, there is shown an example in which the electrical appliance 1 is a transformer. However, the present invention is also applicable to cases where the electrical appliance is another electrical appliance such as a motor, a capacitor, etc.

### INDUSTRIAL APPLICABILITY

The present invention is applicable not only to the above-described electrical appliances but also to industrial products in general as manufactured goods in which a metal part is coated with a thermosetting resin, and the range of use thereof is wide, making it possible to easily collect a metal part from discarded products which have been otherwise difficult in processing due to the amount of time and effort required, thereby contributing to efficient collection and recycle of metal resources.

### DESCRIPTION OF SYMBOLS

1: Electrical appliance
2: Iron core (metal part)
3: Coil (metal part)
4: Thermosetting resin

1. A method in which a metal part is taken out from an electrical appliance which contains the metal part coated with a thermosetting resin, and the method for taking out the metal part from the electrical appliance which includes a step in which the electrical appliance is exposed to an atmosphere filled with superheated steam to carbonize the thermosetting resin, a step in which an impact is applied to the thermosetting resin which is made fragile by carbonization to cause destruction and a step in which the metal part is separated from the destroyed thermosetting resin.

2. The method for taking out the metal part from the electrical appliance according to claim 1, wherein a temperature of the superheated steam is within a range of 200° C. to 600° C.

3. The method for taking out the metal part from the electrical appliance according to claim 1, wherein the metal part is taken out from the electrical appliance by using a carbonization apparatus in a step in which the electrical appliance is exposed to an atmosphere filled with superheated steam to cause carbonization.

4. The method for taking out the metal part from the electrical appliance according to claim 2, wherein the metal part is taken out from the electrical appliance by using a carbonization apparatus in a step in which the electrical appliance is exposed to an atmosphere filled with superheated steam to cause carbonization.
